(19) United States
(12) Patent Application Publication
(10) Pub. No.: US 2016/0026215 A1
(43) Pub. Date: Jan. 28, 2016

(54) WEARABLE DEVICE WITH ATTACHABLE EXPANSION PACK

(71) Applicant: JayBird LLC, Salt Lake City, UT (US)

(72) Inventor: JUDD ARMSTRONG, Parrearra (AU)

(73) Assignee: JAYBIRD LLC, Salt Lake City, UT (US)

(21) Appl. No.: 14/807,810

(22) Filed: Jul. 23, 2015

Related U.S. Application Data
(60) Provisional application No. 62/029,356, filed on Jul. 25, 2014.

(51) Int. Cl. G06F 1/16; H02J 7/00

(52) U.S. Cl. CPC G06F 1/163; H02J 7/0054; H02J 7/0045; G06F 1/1698

(57) ABSTRACT

A wearable device and methods for using the same are provided. In one embodiment, the wearable device includes a band and expansion pack. The band includes a first set of magnets and a first set of modules. The expansion pack includes a second set of magnets and a second set of modules. The wearable device is configured to electrically couple at least one module of the first set of modules to at least one module of the second set of modules through at least one magnet of the first set of magnets and at least one magnet of the second set of magnets when the expansion pack is magnetically fastened to the band.

### CROSS-REFERENCE TO RELATED APPLICATIONS

This application claims the benefit of and priority to U.S. Provisional Application Ser. No. 62/029,356, filed Jul. 25, 2014, titled “Wearable Device with Attachable Expansion Pack,” the entirety of which is incorporated herein by reference. In addition, U.S. patent application Ser. No. 14/062,815, filed Oct. 24, 2013, titled “Wristband with Removable Activity Monitoring Device,” is incorporated herein by reference in its entirety.

### TECHNICAL FIELD

The present disclosure relates generally to wearable electronic devices, and more particularly to battery powered fitness monitoring devices.

### BACKGROUND

Previous generation wearable electronic monitoring devices require periodic charging in order to maintain acceptable power levels. This typically requires plugging the wearable device into a stationary power source, or at least a power source that is less mobile than the wearable device. One issue is that currently available wearable devices must be removed for conventional charging, or must at least be attached to a power source via cords. As such, conventional charging solutions do not allow for the full mobility and use of the wearable device while the device is charging. Moreover, in some cases, particularly where the wearable device is dependent on a power source to collect data continually and without interruption, conventional charging is problematic because it requires interrupting the data collection—typically by removing the device for charging, but also by loss of power. In other cases, where collecting data requires that the wearable device be highly mobile, connecting to a power source may impede data collection.

### SUMMARY

In view of the above drawbacks, there is a long-felt need for wearable electronic devices that may be charged on the go, without being removed and without plugging into a power source. Further, there is a long-felt need for such devices to remain sleek, mobile, lightweight, readily manufacturable, and, in some cases, rugged. In one embodiment of the disclosure, in which the wearable device is a wearable fitness-monitoring device, being sleek, mobile, lightweight, and/or rugged allows a user to perform numerous activities while wearing the device. Moreover, on-the-go charging enables continuous collection of data, such as data relating to the user's activity and the user's physical responses thereto, thus enabling the user to better track a multitude of fitness- and health-related data points. Additionally, there is a long-felt need for wearable devices that are simple and cheap to manufacture.

Various embodiments of the present disclosure include a wearable device with an attachable expansion pack. In one embodiment, the wearable device includes a band and an expansion pack. The band contains a first set of magnets. The expansion pack contains a second set of magnets. Each magnet in the first set of magnets is of opposite polarity from a corresponding magnet in the second set of magnets. As such, the expansion pack fastens to the band by magnetic coupling. In addition to the magnetic coupling, one or more magnets of the first set of magnets are electrically coupled to one or more corresponding respective magnets in the second set of magnets when the expansion pack magnetically fastens to the band. In this manner, the band and the expansion pack are mechanically and electrically coupled, such that various modules, circuits, or components in the band may interact with corresponding modules, circuits, or components in the expansion pack and vice versa. Moreover, using one or more magnets from the first set of magnets and one or more magnets from the second set of magnets as both mechanical and electrical coupling agents reduces part count, cost, and complexity.

### BRIEF DESCRIPTION OF THE DRAWINGS

Further aspects of the present disclosure will be more readily appreciated upon review of the detailed description of the various disclosed embodiments, described below, when taken in conjunction with the accompanying figures.

FIG. 1 illustrates a perspective view of an example wearable device in detached configuration.

FIG. 2 illustrates an additional perspective view of an example wearable device in detached configuration.

FIG. 3 illustrates a perspective view of an example wearable device in attached configuration.

FIG. 4 illustrates a top view of an example wearable device in attached configuration.

FIG. 5 illustrates a side view of an example wearable device in attached configuration.

FIG. 6 illustrates cross-sectional view of an example wearable device in attached configuration.

FIG. 7 illustrates a schematic diagram of an example system that includes a wearable device.

FIG. 8 illustrates a schematic block diagram of an example wearable device.

FIG. 9 is an operational flow diagram illustrating an example method for using a wearable device.

The figures are described in greater detail in the description and examples below, are provided for purposes of illustration only, and merely depict typical or example embodiments of the disclosure. The figures are not intended to be exhaustive or to limit the disclosure to the precise form disclosed. It should also be understood that the disclosure may be practiced with modification or alteration, and that the disclosure may be limited only by the claims and the equivalents thereof.

### DETAILED DESCRIPTION

The present disclosure includes various embodiments of a wearable device with an attachable expansion pack that magnetically and electrically couples to a band of the wearable device.

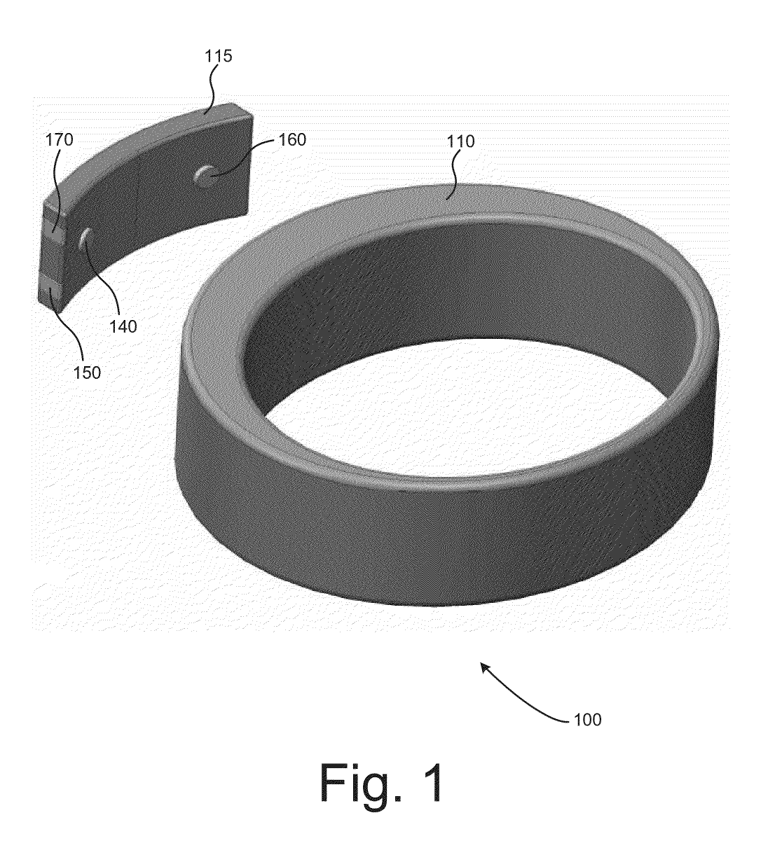

FIG. 1 illustrates a perspective view of an example embodiment of wearable device 100. As illustrated, wearable device 100 includes band 110 and expansion pack 115. In FIG. 1, expansion pack 115 is detached from band 110. Band 110 may, for example, be a comfortable band (e.g., silicone, plastic, and the like) suitable for wearing on a user's body during a number of different activities, including athletic activities, exercise, sleep, work, driving, showering, eating, and so on. As shown in FIG. 1, band 110 may be generally round so as to contour to a user's various limbs. In additional instances, band 110 may attach to an object in addition to the user's body. For example, band 110 may attach to a backpack, oar, bicycle, and so on. Band 110 may be adjustable in size, and include means for size adjustment. In one embodiment, band 110 includes one or more modules that may be in the form of electronic capsules embedded in cavities within band 110. Such modules may include devices such as accelerometers, gyroscopes, processors, logic circuits, biosensors, optical sensors, batteries, circuit boards, modems, amplifiers, wireless transceivers (e.g., GPS, Wi-Fi, Bluetooth, cellular, etc.), integrated circuits, antennae, and the like.

Referring again to FIG. 1, in one embodiment of wearable device 100, expansion pack 115 includes first electrical contact 150, second electrical contact 170, first electromagnetic contact 140, and second electromagnetic contact 160. Expansion pack 115, in one embodiment, is of a similar material to band 110 (e.g., silicone or the like). In the illustrated embodiment, expansion pack 115 is generally rectangular, and generally rounded through its length so as to conform to the rounded shape of band 110. Like band 110, expansion pack 115, in various embodiments, includes embedded devices and/or modules. In different instances, expansion pack 115 may take on any number of various shapes and forms.

In one embodiment of wristband 100, band 110 includes a dock (not shown) that houses expansion pack 115. The dock may include a hollow chamber in band 110. Band 110 may include a dock cover that closes and opens (e.g., by sliding, on a hinge, etc.) to receive and remove expansion pack 115 into and from the dock. In the closed position, the dock cover may protect expansion pack 115 from impacts and other stresses, the elements, and the like. Moreover, when expansion pack 115 is not in the dock, the dock cover may close off the hollow chamber and maintain the streamlined shape of band 110 over the dock, and may allow the dock to be used as storage for other items. Because the dock houses and encompasses expansion pack 115, expansion pack 115 may be used with band 110 without adding bulk to band 110 or wearable device 100.

Referring again to FIG. 1, in the illustrated embodiment, first electrical contact 150 and second electrical contact 170 are depicted as being on an edge of expansion pack 115. In various embodiments, however, first and second electrical contacts 150 and 170 are located in various positions on expansion pack 115. For example, first and second electrical contacts 150 and 170 may each (or both) be located on any edge of expansion pack 115, may be located on an inner-facing surface of expansion pack 115 (i.e., the curved surface that is contoured to band 110), or on an outer-facing surface of expansion pack 115.

Moreover, although FIG. 1 depicts first and second electrical contacts 150 and 170 as being located on the same edge or surface as each other and as proximal one another, first and second electrical contacts 150 and 170 may be located in different locations of expansion pack 115, relative to one another. First and second electrical contacts 150 and 170 may generally be of a material that conducts electricity. In one embodiment, first and second electrical contacts 150 and 170 connect various electronic components or modules housed in expansion pack 115 to various electronic components or modules housed in band 110 via corresponding third and fourth electrical contacts (not shown) located on band 110. In various embodiments, first and second electrical contacts 150 and 170 are omitted from expansion pack 115. Upon studying the present disclosure, one of skill in the art will appreciate that, in some embodiments, electrical contacts may function as or electromagnetic contacts. In other embodiments, electromagnetic contacts may function as or be referred to as electrical contacts herein, though an electrical contact need not be made from magnetic material.

In the illustrated embodiment of FIG. 1, first and second electromagnetic contacts 140 and 160 are located on the inner surface of expansion pack 115. In various embodiments, however, first and second electromagnetic contacts 140 and 160 are located in various positions on expansion pack 115. For example, first and second electromagnetic contacts 140 and 160 may each (or both) be located on any edge of expansion pack 115. Moreover, although FIG. 1 depicts first and second electromagnetic contacts 140 and 160 as being located on the same edge or surface as each other and as proximal one another, first and second electromagnetic contacts 140 and 160 may be located in disparate locations of expansion pack 115, relative to one another. First and second electromagnetic contacts 140 and 160 may generally be of a material that conducts electricity and/or that is magnetically polarized (or magnetized). In one embodiment, first and second electromagnetic contacts 140 and 160 connect various electronic components housed in expansion pack 115 to various electronic components housed in band 110 via corresponding third and fourth electromagnetic contacts (not shown) located on band 110.

In various embodiments of wearable device 100, band 110 includes a first set of magnets. Band 110, in one instance, has a first band opening, through which a portion of a first magnet of the first set of magnets is exposed. The exposed portion of the first magnet of the first set of magnets forms a third electromagnetic contact (not shown in FIG. 1). Band 110 also has a second band opening, through which a portion of a second magnet of the first set of magnets is exposed. The exposed portion of the second magnet of the first set of magnets forms a fourth electromagnetic contact (not shown in FIG. 1).

In one embodiment, expansion pack 115 includes a second set of magnets. In such an embodiment, expansion pack 115 has a first pack opening through which a portion of a first magnet of the second set of magnets is exposed. The exposed portion of the first magnet of the first set of magnets forms first electromagnetic contact 140. Similarly, in this embodiment, expansion pack 115 has a second pack opening, through which a portion of a second magnet of the second set of magnets is exposed. The exposed portion of the second magnet of the second set of magnets forms second electromagnetic contact 160.

In various embodiments, first and second electromagnetic contacts 140 and 160, and any other electromagnetic contacts, are physically separate from respective first and second magnets of the second set of magnets, but are electrically coupled to respective first and second magnets of the second set of magnets. For example, first electromagnetic contact 140 may be an exposed portion of metal on the inner surface of expansion pack 115, and may be electrically coupled to the corresponding first magnet. However, the corresponding first magnet may not be proximal first electromagnetic contact 140, instead residing, for example, along a vertical sidewall of expansion pack 115.

When expansion pack 115 is brought into a position proximal to band 110, the first set of magnets attracts the second set of magnets and magnetically fastens expansion pack 115 to band 110. In one embodiment, expansion pack 115 and/or band 110 includes means for aligning expansion pack 115 to band 110. For example, such means may include a guide pin or flange extending from expansion pack 115 with a corresponding guide slot in band 110. The guide pin or flange may mate to the slot to ensure that the first and second sets of magnets fasten expansion pack 115 to band 110 in a certain position or alignment (e.g., with first and second electromagnetic contacts 140 and 160 contacting the third and fourth electromagnetic contacts).

In another embodiment, expansion pack 115 and band 110, are aligned manually by the user. There may be markings on expansion pack 115 and/or band 110 that guide this alignment. When aligned, the first electromagnetic contact 140 (on expansion pack 115) makes an electrical connection to the third electromagnetic contact (on band 110), and second electromagnetic contact 160 (on expansion pack 115) makes an electrical connection to the fourth electromagnetic contact (on band 110). In a further embodiment, alignment means include the polarization of various magnets in the first set of magnets and various corresponding magnets in the second set of magnets. For example, particular polarization patterns may allow expansion pack 115 to fasten magnetically to band 110 in only one specific, properly aligned position.

Expansion pack 115, in various embodiments, houses various components, devices, and/or modules. For example, expansion pack 115 may house an energy storage device, such as a battery; circuitry capable of receiving and transmitting wireless signals, including, for example, cellular signals (e.g., LTE, WiMAX, CDMA, GPS, etc.), Wi-Fi, Bluetooth, TV or radio broadcast signals, and so on; memory circuits (e.g., RAM, flash storage, or other solid-state memory); processing circuits (e.g., an applications processor or a portion thereof); sensors (e.g., gyroscope, accelerometer, hygrometer, altimeter, temperature sensor, and so on); and the like. Such components, devices, and modules may couple to circuitry and other components, devices, modules, displays, etc. in band 110 by way of first and second electromagnetic contacts 140 and 160 and/or first and second electrical contacts 150 and 170. Moreover, expansion pack 115 may include additional electrical and electromagnetic contacts in embodiments in which additional input/output capabilities are required (and band 110 may include additional corresponding contacts as well). In addition, expansion pack modules may be communicatively coupled to band modules via a communication medium.

In one embodiment, expansion pack 115 houses a first energy storage device. The first energy storage device may store electrical charge, and may have a positive terminal and a negative terminal. The positive terminal is coupled to first electromagnetic contact 140, and the negative terminal is coupled to second electromagnetic contact 160. Likewise, the third and fourth electromagnetic contacts are coupled to positive and negative terminals, respectively, of a second energy storage device that resides in band 110. As such, the first energy storage device may transfer energy to the second energy storage device.

In one particular instance, the first and second energy storage devices are first and second batteries, and the first battery charges the second battery. In this manner, expansion pack 115 can be used as a convenient way to charge a battery (i.e., the second battery, in this instance) inside band 110, as follows. Expansion pack 115 is brought into proximity with band 110 and is aligned therewith. The first set of magnets attracts the second set of magnets, fastening expansion pack 115 to band 110. Once fastened and aligned (i.e., the band electrical and electromagnetic contacts make electrical connection with the expansion pack electrical and electromagnetic contacts), the first battery (in expansion pack 115) charges the second battery (in band 110) by electrical current flowing through electromagnetic contacts 140 and 160. In other words, the first battery charges the second battery through at least a subset of the magnets that magnetically fasten expansion pack 115 to band 110. Similarly, when expansion pack 115 includes additional modules or devices, first and second electromagnetic contacts 140 and 160, and electrical contacts 150 and 170, may also be used as input/output terminals may be used for various signals (e.g., wireless, data, sensor, etc.), as may the communication medium. Using the magnets to for both fastening and electrical coupling purposes has several potential benefits, including reduced part count, complexity, and cost.

As an attachable charging device for modules embedded within band 110, various embodiments of expansion pack 115 allow for power utilization (i.e., by band 110 modules) without interruption for charging. On-the-go charging enables continuous monitoring and data-gathering for applications such as monitoring sleep, medical conditions, health, and activity (or other vitals). Such continuous monitoring provides for a robust data set that would not be achievable with a device that must be detached for charging.

Further embodiments of the disclosure include a ruggedized wearable device 100. In some such embodiments, a dock is used to streamline the form factor of wearable device 100 when expansion pack 115 is magnetically fastened to band 110. Moreover, in other instances, stronger magnets are used to create a stronger coupling between expansion pack 115 and band 110. This stronger coupling may prevent expansion pack 115 from detaching from band 110 under high impacts. In additional scenarios, expansion pack 115 is configured to form a seal with band 110 around the outer edge of expansion pack 115 when expansion pack 115 is magnetically fastened to band 110. The seal may be used to keep dirt, water, and the elements from corrupting or otherwise affecting the connection between expansion pack 115 and band 110. In further embodiments, band 110 includes additional fastening means (e.g., clamps, friction seal, etc.) that, in addition to the magnetic coupling, provide a stronger mechanical connection between expansion pack 115 and band 110.

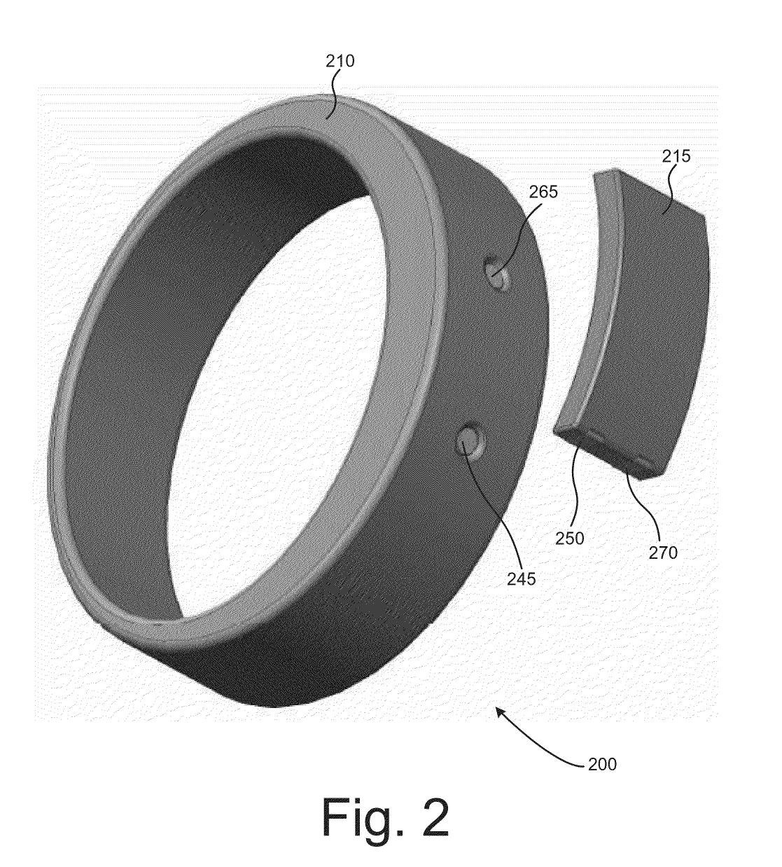

FIG. 2 illustrates a perspective view of one embodiment of wearable device 200. As illustrated, this embodiment of wearable device 200 includes band 210 and expansion pack 215. In FIG. 2, expansion pack 215 is detached from band 210. Band 210, in various embodiments, is substantially similar to band 110, described above with regard to FIG. 1. Band 210 includes third electromagnetic contact 245 and fourth electromagnetic contact 265. Third and fourth electromagnetic contacts 245 and 265 were described above with regard to FIG. 1 (though not numbered because they were not shown in FIG. 1). In particular, third electromagnetic contact 245 is an exposed portion of a first magnet of the first set of magnets in band 210, and fourth electromagnetic contact 265 is an exposed portion a second magnet of the first set of magnets in band 210.

In a fashion substantially similar to first and second electromagnetic contacts 140 and 160, when expansion pack 215 includes additional modules or devices, third and fourth electromagnetic contacts 245 and 265 and band electrical contacts (not shown) may be used as input/output terminals for various signals (e.g., wireless, data, sensor, etc.) to couple in and out of band 210.

In the instance in which expansion pack 215 houses a first battery for charging a second battery embedded in band 210, similar to the example described above, expansion pack 215 is brought into proximity with band 210 and is aligned therewith. The first set of magnets then attracts the second set of magnets, fastening expansion pack 215 to band 210. Once fastened and aligned (i.e., the band electrical and magnetic contacts make electrical connection with the expansion pack electrical and magnetic contacts), the first battery (in expansion pack 215) charges the second battery (in band 210) by electrical current flowing through at least a subset of the first and second sets of magnets that fasten expansion pack 215 to band 210. In other words, current flows from the first battery through at least one magnet of the second set of magnets, through the first and second electromagnetic contacts (not shown in FIG. 2), through third and fourth electromagnetic contacts 245 and 265, and through at least one magnet in the first set of magnets, and finally into the second battery.

In the embodiment illustrated in FIG. 2, expansion pack 215 includes first and second electrical contacts 250 and 270, which are substantially similar to electrical contacts 150 and 170, respectively. Expansion pack 215 also includes first and second electromagnetic contacts (not shown in FIG. 2) that are substantially similar to first and second electromagnetic contacts 140 and 160, described above with respect to FIG. 1.

in various embodiments, band 210 (similar to band 110) includes a dock (not shown) that houses expansion pack 215. In some such embodiments, third and fourth electromagnetic contacts 245 and 260 may reside in a depressed portion of band 210 that forms the hollow chamber of the dock. In some instances, due to band 210 being thinner under the dock, the first set of magnets is placed in areas of band 210 other than under the dock. For example, the first set of magnets may be placed in proximity to vertical or sloped sidewalls of the dock. Likewise, the second set of magnets may be adjusted within expansion pack 215 to align with the first set of magnets. In alternative embodiments, third and fourth electromagnetic contacts 245 and 265 reside in other portions of band 210. For example, third and fourth electromagnetic contacts 245 and 265 may reside in the vertical or sloped sidewalls of the dock. First and second electrical contacts 250 and 270 may likewise take various positions on expansion pack 215.

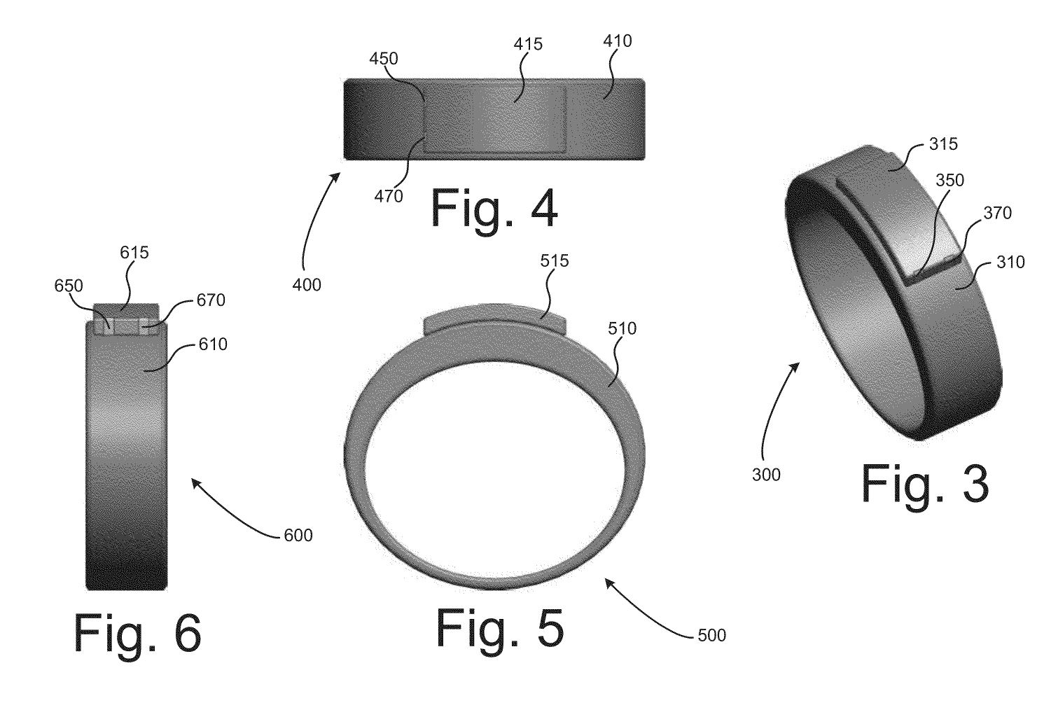

FIG. 3 illustrates an additional perspective view of an example embodiment of wearable device 300. As illustrated, wearable device 300 includes expansion pack 315 and band 310. In FIG. 3, expansion pack 315 is magnetically fastened to band 310. Expansion pack 315, in this embodiment, includes first and second electrical contacts 350 and 370. Wearable device 300 is substantially similar to wearable devices 100 and 200, described above with regard to FIGS. 1 and 2.

FIG. 4 illustrates a top view of an example embodiment of wearable device 400. As illustrated, wearable device 400 includes expansion pack 415 and band 410. In FIG. 4, expansion pack 415 is magnetically fastened to band 410. Expansion pack 415, in this embodiment, includes first and second electrical contacts 450 and 470. Wearable device 400 is substantially similar to wearable devices 100 and 200, described above with regard to FIGS. 1 and 2.

FIG. 5 illustrates a side view of an example embodiment of wearable device 500. As illustrated, wearable device 500 includes expansion pack 515 and band 510. In FIG. 5, expansion pack 515 is magnetically fastened to band 510. Wearable device 500 is substantially similar to wearable devices 100 and 200, described above with regard to FIGS. 1 and 2.

FIG. 6 illustrates a cross-sectional view of an example embodiment of wearable device 600. As illustrated, wearable device 600 includes expansion pack 615 and band 610. In FIG. 6, expansion pack 615 is magnetically fastened to band 610. Expansion pack 615, in this embodiment, includes first and second electrical contacts 650 and 670. Wearable device 600 is substantially similar to wearable devices 100 and 200, described above with regard to FIGS. 1 and 2.

As illustrated in FIG. 6, expansion pack 615 resides in a dock in band 610, rather than on the surface of band 610 (as in FIG. 5). The depth of the dock in band 610 is about one-half the thickness of expansion pack 615. As such, the protrusion of expansion pack 615 from band 610 is reduced by roughly one half, thus streamlining the form factor of wearable device 600. As described above, in various embodiments, expansion pack 615 resides entirely within band 610.

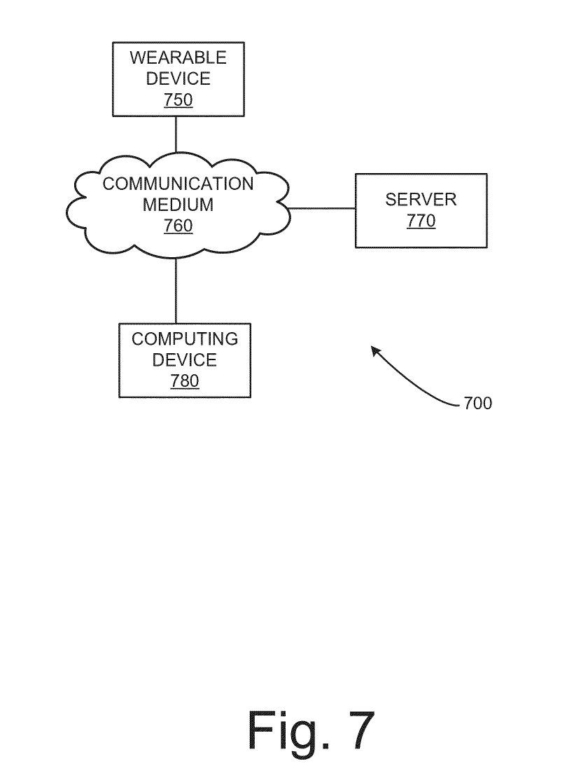

FIG. 7 is a schematic block diagram illustrating example system 700, which represents an operating environment for an example embodiment of wearable device 750. As illustrated, system 700 includes wearable device 750, communication medium 760, computing device 780, and server 770. Wearable device 750, in various embodiments, is substantially similar to wearable devices 100-600, described above.

Communication medium 760 connects wearable device 750 to various other systems and modules, represented by computing device 780 and server 770. Communication medium 760 may be implemented in a variety of forms. For example, communication medium 760 may be an Internet connection, such as a local area network (“LAN”), a wide area network (“WAN”), a fiber optic network, internet over power lines, a hard-wired connection (e.g., a bus), and the like, or any other kind of network connection. Communication medium 760 may be implemented using any combination of routers, cables, modems, switches, fiber optics, wires, radio, and the like. Communication medium 760 may be implemented using various wireless standards, such as Bluetooth, Wi-Fi, 4G LTE, etc. One of skill in the art will recognize other ways to implement communication medium 760 for communications purposes.

Computing device 780 may take a variety of forms, such as a desktop or laptop computer, a smartphone, a tablet, a processor, a wearable device, a module, or the like. In addition, computing device 780 may be a processor or module embedded in a wearable device (e.g., wearable device 750), including a sensor, a bracelet, a smart-watch, a piece of clothing, an accessory, and so on. For example, computing device 780 may be substantially similar to devices embedded in wearable device 750, which may be embedded in and removable from band 110. Computing device 780 may communicate with other devices via communication medium 760 with or without the use of server 770. In various embodiments, wearable device 750 may be used to perform various processes described herein.

Server 770 directs communications made over communication medium 760. Server 770 may be, for example, an Internet server, a router, a desktop or laptop computer, a smartphone, a tablet, a processor, a module, or the like. In one embodiment, server 770 directs communications between communication medium 760 and computing device 780. For example, server 770 may update information stored on computing device 780, or server 770 may send information to computing device 780 in real time.

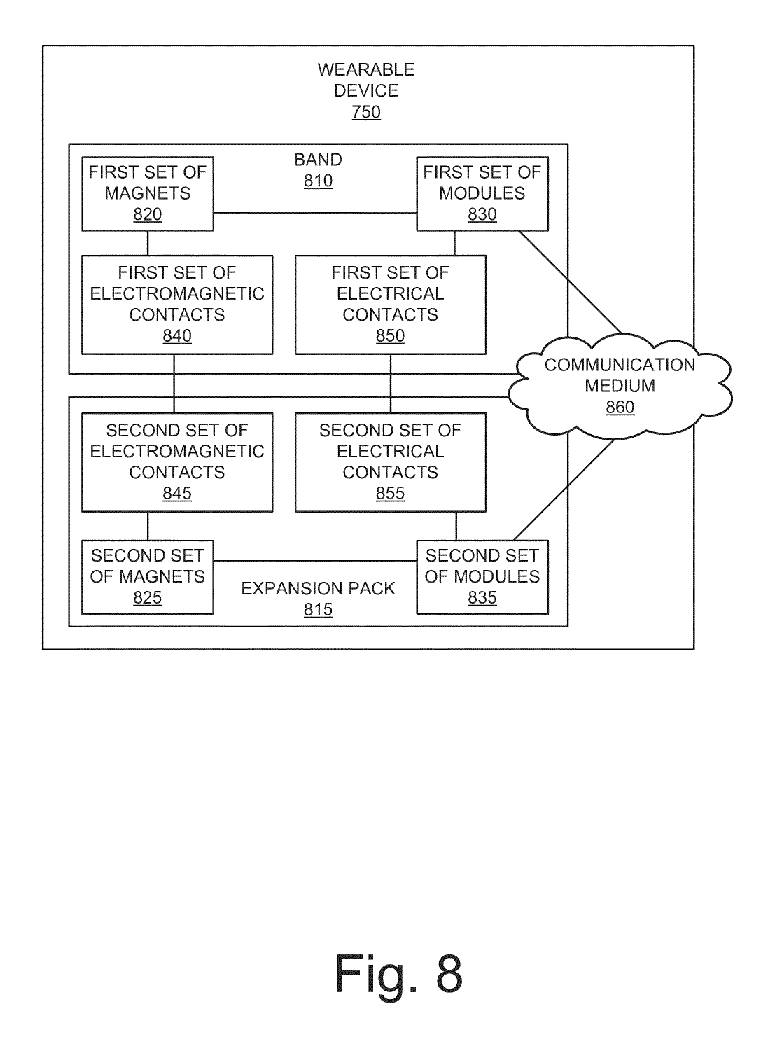

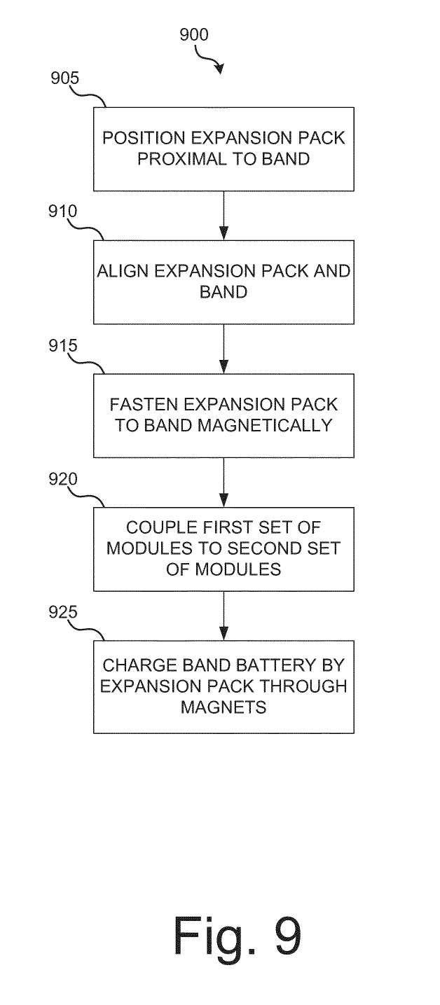

FIG. 8 is a schematic block diagram illustrating an example embodiment of wearable device 750. Wearable device 750 includes band 810, expansion pack 815, and communication medium 860. Communication medium 860 may be substantially similar to communication medium 760, and may communicatively couple band 810 to expansion pack 815. Additionally, communication medium 860 may include various wired connections, such that modules in expansion pack 815 may couple to modules in band 810 by, for example, direct connect interface (e.g., micro-USB port and the like).

Band 810 includes first set of magnets 820, first set of modules 830, first set of electromagnetic contacts 840, and first set of electrical contacts 850. As shown, first set of magnets 820 is coupled to first set of modules 830 and is coupled to first set of electromagnetic contacts 840. First set of modules 830 is coupled to first set of electrical contacts 850 and to communication medium 860. In various embodiments, first set of electromagnetic contacts 840 is formed from or part of first set of magnets 820.

Expansion pack 815 includes second set of magnets 825, second set of modules 835, second set of electromagnetic contacts 845, and second set of electrical contacts 855. As shown, second set of magnets 825 is coupled to second set of modules 835 and is coupled to second set of electromagnetic contacts 845. In various embodiments, second set of electromagnetic contacts 845 is formed from or part of second set of magnets 825. Second set of modules 835 is coupled to second set of electrical contacts 855 and to communication medium 860. As first and second sets of modules 830 and 835 are both coupled to communication medium 860, in addition to interacting via electromagnetic and electrical contacts (840, 845, 850, 855), first set of modules 830 may interact with second set of modules 835 via all forms of communication supported by communication medium 860.

One embodiment of wearable device 750 charges a first battery in band 810 through first and second sets of magnets 820 and 825 using a second battery embedded in expansion pack 815. In such an embodiment, second set of modules 835 includes the second battery. The second battery may itself be charged by conventional means, such as by plugging expansion pack 815 into an AC outlet, by USB, by wireless charging, and so on. Expansion pack 815 is brought into proximity with band 810 and is aligned thereto. First set of magnets 820 attracts second set of magnets 825, fastening expansion pack 815 to band 810. If properly aligned, first set of electromagnetic contacts 840 contacts second set of electromagnetic contacts 845 and first set of electrical contacts 850 contacts second set of electrical contacts 855. Current may then flow from the second battery, through one or more magnets of second set of magnets 825, through one or more of second set of electromagnetic contacts 845, through one or more of first set of electromagnetic contacts 840, through one or more magnets of first set of magnets 820, and into the first battery. In various embodiments, first and second sets of modules 830 and 835 include logic and circuitry to control the flow of current between the first and second batteries.

Expansion pack 815, in one instance, provides expanded processing power to a processor in band 810. In such an instance, second set of modules 835 includes second processing means. Expansion pack 815 is magnetically fastened to and aligned with band 810. First processing means in first set of modules 830 is then coupled to the second processing means via one or more of first and second sets of electromagnetic contacts 840 and 845, first and second sets of electrical contacts 850 and 855, and communication medium 860. In this manner, expansion pack 815 may allow the first processing means to perform functions and capabilities not otherwise possible without the addition of the second processing means.

Expansion pack 815, in another instance, provides cellular capabilities to circuitry in band 810. In such an instance, second set of modules 835 includes a cellular transceiver and other means for connecting to a cellular network (e.g., LTE, WiMAX, CDMA, etc.). Communication medium 860 may then transfer cellular data between second set of modules 835 and first set of modules 830.

Accordingly, expansion pack 815 enables various modes of use through which expansion pack 815 expands the capabilities of band 810. In various embodiments, band 810 detects which mode of use is to be employed based on an orientation of expansion pack 815 relative to band 810. For example, if expansion pack 815 is aligned in a first orientation (e.g., with a first and a second electromagnetic contact of first set of electromagnetic contacts 840 respectively contacting a third and a fourth electromagnetic contact of second set of electromagnetic contacts 845), this may indicate a battery charging mode of use. In this mode, a second battery in expansion pack 815 may, for example, charge a first battery in band 810. On the other hand, if expansion pack 815 is aligned in a second orientation (e.g., with the first and the second electromagnetic contact of first set of electromagnetic contacts 840 respectively contacting the fourth and the third electromagnetic contact of second set of electromagnetic contacts 845), this may indicate cellular mode of use. In cellular mode, a cellular module in second set of modules 835 may provide cellular capability to modules in first set of modules 830.

Modes of use may be triggered using alignment detection signals passed between first and second sets of modules 830 and 835, and/or using one or more magnets in first and second sets of magnets 820 and 825 to detect alignment (e.g., by magnetically controlling detection circuits). In an alternative embodiment, modes of use may be selected or configured using an interface on either band 810 or expansion pack 815.

FIG. 9 is an operational flow diagram illustrating example method 900 for using a wearable device with an attachable expansion pack. The wearable device may be substantially similar to the wearable devices describe above (e.g., wearable device 100 and wearable device 750). One embodiment of method 900 includes magnetically fastening the expansion pack to a band so that a first battery in the expansion pack may charge a second battery in the band.

At operation 905, method 900 includes positioning the expansion pack proximal to the band. At operation 910, method 900 further includes aligning the expansion pack with the band. Operation 910 may include aligning one or more electromagnetic contacts of the band with one or more electromagnetic contacts of the expansion pack. At operation 915, method 900 includes fastening the expansion pack to the band magnetically by magnetic forces created between a first set of magnets in the expansion pack and a second set of opposing magnets in the band. At operation 920, method 900 includes coupling a first set of modules in the expansion pack to a second set of modules in the band. One instance of method 900 includes, at operation 925, charging a battery in the second set of modules (in the band) by a battery in the first set of modules (in the expansion pack) through the first set of magnets in the expansion pack and the second set of opposing magnets in the band. Additional processes may be performed as described herein in detail with regard to FIGS. 1 through 8.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of example block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various example embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

What is claimed is:

1. A wearable device, comprising:
a band, comprising:
a first set of magnets; and
a first set of modules; and
an expansion pack, comprising:
a second set of magnets; and
a second set of modules;
wherein at least one module of the first set of modules is electrically coupled to at least one module of the second set of modules through at least one magnet of the first set of magnets and at least one magnet of the second set of magnets when the expansion pack is magnetically fastened to the band.

2. The wearable device of claim 1, wherein the second set of modules comprises receiver circuitry.

3. The wearable device of claim 1, wherein a module of the second set of modules comprises an energy storage device.

4. The wearable device of claim 3, wherein a module of the first set of modules comprises a chargeable battery, and wherein, when the expansion pack is magnetically fastened to the band, the energy storage device is configured to deliver charge to the chargeable battery through the at least one magnet of the first set of magnets and the at least one magnet of the second set of magnets.

5. The wearable device of claim 1, wherein the expansion pack comprises first and second electrical contacts coupled to one or more modules of the second set of modules.

6. The wearable device of claim 5, wherein a first magnet of the second set of magnets comprises the first electrical contact, and wherein a second magnet of the second set of magnets comprises the second electrical contact.

7. The wearable device of claim 1, wherein the band comprises a dock configured to house the expansion pack.

8. The wearable device of claim 7, wherein the band further comprises a dock cover that is closeable such that the expansion pack resides within the dock and is covered by the dock cover when the dock cover is closed.

9. The wearable device of claim 1, wherein the band comprises a band opening that exposes at least a portion of a magnet of the first set of magnets, wherein the expansion pack comprises a pack opening that exposes at least a portion of a magnet of the first set of magnets, and wherein the exposed portions of the magnets electrically couple the magnet of the first set of magnets to the magnet of the second set of magnets when the expansion pack is magnetically fastened to the band.

10. The wearable device of claim 1, further comprising means for aligning the expansion pack to the band, such that the first and second sets of magnets attract and fasten the band to the expansion pack.

11. A method of using a wearable device with an expansion pack, the method comprising:
positioning the expansion pack proximal to the wearable device, the wearable device comprising a first magnet, the expansion pack comprising a second magnet;
fastening the expansion pack to the band by way of magnetic forces between the first and second magnets; and
electrically coupling a first module in wearable device to a second module in the expansion pack via the first and second magnets.

12. The method of claim 11, further comprising aligning the expansion pack with a band of the wearable device.

13. The method of claim 11, wherein the first module is a battery, and further comprising charging the battery via the first and second magnets.

14. The method of claim 11, wherein fastening the expansion pack to the band comprises receiving the expansion pack into a dock of the band.

15. The method of claim 14, further comprising covering the expansion pack using a dock cover of the band.

16. A wearable device with an attachable expansion pack that electrically couples and fastens to a band of the wearable device using a first magnet in the wearable device and a second magnet in the expansion pack, wherein:
the band comprises a first electrical contact coupled to a first module in the wearable device via the first magnet;
the expansion pack comprises a second electrical contact coupled to a second module in the expansion pack via the second magnet; and
the first and second electrical contacts and the first and second magnets electrically couple the band to the expansion pack.

17. The wearable device of claim 16, wherein the first module is connected to the second module via a communication medium.

18. The wearable device of claim 16, wherein the band further comprises a dock configured to house the expansion pack when the expansion pack fastens to the band.

19. The wearable device of claim 18, wherein the band further comprises a dock cover that opens to receive the expansion pack into the dock and that, when closed, forms a seal around the dock.

20. The wearable device of claim 18, wherein the dock is formed as a hollow chamber in the band, such that the thickness of the band is roughly uniform when the expansion pack is housed in the dock.
